(19) United States
(12) Patent Application Publication
(10) Pub. No.: US 2018/0357598 A1
(43) Pub. Date: Dec. 13, 2018

(54) Systems, Devices, and Methods for Monitoring Packages with Affixed Sensors

(71) Applicant: Walmart Apollo, LLC, Bentonville, AR (US)

(72) Inventor: Jonathan M. Williams, Rogers, AR (US)

(21) Appl. No.: 16/002,342

(22) Filed: Jun. 7, 2018

Related U.S. Application Data
(60) Provisional application No. 62/517,313, filed on Jun. 9, 2017.

(51) Int. Cl. G06Q 10/08; G06K 7/06

(52) U.S. Cl. CPC G06Q 10/087; G06K 7/06

(57) ABSTRACT

Methodologies, systems, and computer-readable media are provided for monitoring packages with affixed sensors. A number of sensors attached to product packaging are configured to communicate with each other and select a master sensor from among themselves. The master sensor can interrogate the remaining sensors and relay quantity and location data to a computing system. A replacement master sensor can be selected if the master sensor loses communication with the other sensors for a predetermined period of time, and the master sensor and replacement master sensor can be selected based on a comparison of battery life or signal strength. At least a subset of the sensors other than the master sensor and replacement master sensor can be placed in a low power mode.

### RELATED APPLICATIONS

This application claims priority to U.S. Provisional Patent Application No. 62/517,313 entitled “SYSTEMS, DEVICES, AND METHODS FOR MONITORING PACKAGES WITH AFFIXED SENSORS,” filed on Jun. 9, 2017, the contents of which are hereby incorporated by reference in their entirety.

### BACKGROUND

Various types of products can be disposed and subsequently moved within and from a facility. Maintaining a proper inventory sometimes involves monitoring the location of individual products.

### SUMMARY

Embodiments of the present invention utilize distributed sensors to form a communication network to track packages within a facility. In one embodiment, a system for monitoring packages with affixed sensors within a facility includes multiple sensors that are each associated with, and affixed to, one of a group of packages. Each of the sensors is configured to communicate with each other over a first communication channel. The system also includes a master sensor selected from the sensors. The master sensor is configured to periodically retrieve quantity data associated with the packages and geographical location data associated with the packages by interrogating the other sensors over the first communication channel. The system also includes a computing system in communication with the master sensor over a second communication channel. The computing system is configured to execute a geolocation module to receive the quantity data and the geographical location data associated with the packages from the master sensor, and dynamically update a database to include the quantity data and the geographical location data. The system also includes a replacement master sensor selected from the sensors in response to the master sensor failing to communicate with the other sensors over the first communication channel for a predetermined period of time. The replacement master sensor is selected based on predefined criteria following the other sensors communicating with each other over the first communication channel after the master sensor fails to communicate for a predetermined period of time. The replacement master sensor is configured to periodically retrieve the quantity data and the geographical location data associated with the packages by interrogating the other sensors over the first communication channel. The master sensor is also configured to automatically initiate communication with the computing system over the second communication channel to transmit the quantity data and the geographical location data associated with the packages to the computing system. The master sensor and replacement master sensor are placed in an active power mode, and at least a subset of the other sensors are placed in a low power mode when not communicating over the second communication channel.

Additional combinations and/or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings are primarily for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present invention will be more fully understood from the following description of exemplary embodiments when read together with the accompanying drawings, in which:

FIG. 1 is a flowchart illustrating an exemplary method for monitoring packages with affixed sensors, according to an exemplary embodiment.

FIG. 2 is a flowchart illustrating another exemplary method for communicating with a mobile device using a master sensor, according to an exemplary embodiment.

FIG. 3 is a diagram of an exemplary network environment suitable for a distributed implementation of an exemplary embodiment.

FIG. 4 is a block diagram of an exemplary computing device that can be used to perform exemplary processes in accordance with an exemplary embodiment.

### DETAILED DESCRIPTION

Following below are more detailed descriptions of various concepts related to, and embodiments of, inventive methods, apparatus, and systems for associating delivery information with a remotely located package. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to”, the term “including” means “including but not limited to”. The term “based on” means “based at least in part on”.

Conventional inventory techniques require an individual to physically locate and log the quantity and location of items. Even the use of handheld scanning devices requires an individual to scan each item. Methodologies, systems, apparatus, and non-transitory computer-readable media are described herein to facilitate communication between sensors located on consumer packaged goods over a communication network. Each sensor associated with a product can include an embedded or printed circuit that can communicate with the other sensors in a particular area and provide in-store location and quantity data. In exemplary embodiments, each sensor can act as a disposable wireless beacon.

In exemplary embodiments, sensors including microcircuits or printed electronics can be embedded or affixed to product package in order to create a wireless network between the sensors. Such a network can enable monitoring of individual inventory items without the need for RFID tags. In exemplary embodiments, Bluetooth low energy (BLE), Wi-Fi, or NFC technology can be integrated into the sensors within product packages. One of the sensors in a group of like items can assume a master role and become a master sensor. The master sensor can collect quantity and location data from the other sensors affixed to the product packages and communicate with a computing system in the facility, such as a retail facility or a warehouse environment, via a Wi-Fi network, or some other communication channel, in order to provide the quantity and location data. In exemplary embodiments, the master sensor can remain in an active power mode, while the remaining non-master sensors switch to a low power mode except at designated times in order to preserve battery life. If one of the sensors is moved out of range of the master sensor, the master sensor can detect a reduced number of sensors and transmit updated quantity or location data to the computing system. If the master sensor itself is moved out of range of the remaining sensors such as may occur if a customer in a retail facility took a package containing the master sensor for purchase, the remaining sensors can communicate among themselves in order to select a replacement master sensor. The initial master sensor, as well as the replacement master sensor, can be selected based on a comparison of battery strength or signal strength between all the sensors.

In exemplary embodiments, the master sensor can periodically interrogate the remaining sensors, using very low energy communication, and maintain quantity and location data corresponding to each of the sensors. The master sensor can also communicate with a remote computing system in order to provide the quantity and location data to the computing system and maintain an accurate inventory. In exemplary embodiments, the master sensor also has the ability to communicate with various mobile smart devices to provide item specific metadata.

In exemplary embodiments, the various sensors can be circuits printed on or embedded within product packaging. If a sensor battery is about to die, the sensor can send a communication, either to the master sensor or the computing system, in order to transmit the last known location of the sensor. The master sensor can also detect the presence of, and communicate with, a mobile electronic device in the immediate vicinity of the sensor. The master sensor can track data relating to the user of the mobile electronic device, such as time spent near the product, whether one or more of the products was retrieved, etc. The master sensor can also relay a customized message or notification to the mobile electronic device while the device is within range of the master sensor. In some embodiments, the master sensor can retrieve identification data from the mobile electronic device and relay this data back to the computing system. The computing system can access a personalized account associated with the user of the mobile electronic device and generate a personalized notification that the master sensor can relay to the mobile electronic device.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

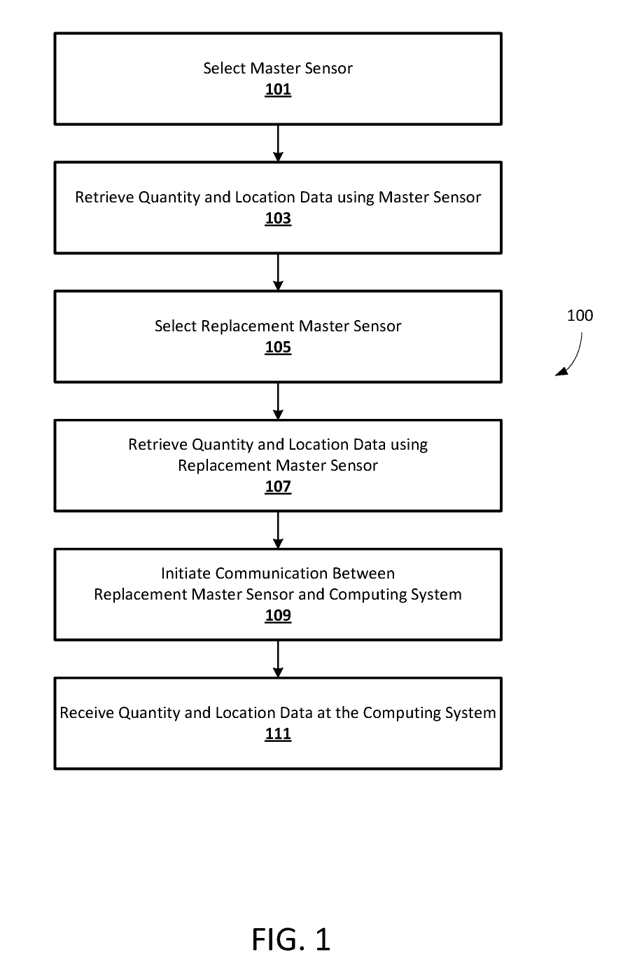

FIG. 1 is a flowchart illustrating an exemplary method 100 for monitoring packages with affixed sensors, according to an exemplary embodiment. It will be appreciated that the method is programmatically performed, at least in part, by one or more computer-executable processes executing on, or in communication with one or more servers described further below. In step 101, a master sensor is selected from among a group of sensors. Each of the sensors is associated with, and affixed to, one of a group of packages, and each sensor is configured to communicate with each other over a first communication channel. The first communication channel can include, for example, BLE, NFC, or another wireless technology. In exemplary embodiments, the master sensor can be selected based on a comparison of the battery life or signal strength between the sensors. For example, each of the sensors can communicate with each other over the first communication channel and collectively select the sensor with the highest battery charge to be the master sensor. In another example, each of the sensors can communicate with each other over the first communication channel to determine which sensor has the strongest signal for communicating with a central computing system and select that sensor as the master sensor.

In some embodiments, one or more of the sensors can be charged utilizing inductive charging or RF-based wireless charging technology. For example, the sensors can include an antenna or RF receiver that is configured to receive an RF signal, along with an RF to DC converter that can convert the RF signal into an electrical charge in order to prevent the sensors from losing power. In some embodiments, the proximity of the sensors to an RF charging signal can be another factor considered when selecting the master sensor. Additionally conductive ink can be utilized printing a complete or a partial sensor element directly on the associated package within the group of packages.

In step 103, the master sensor retrieves quantity data associated with the group of packages and geographical location data associated with the group of packages from the sensors. The quantity data and geographical location data are retrieved, in some embodiments, by interrogating the other sensors associated with the packages using the master sensor. The master sensor is in communication with a computing system over a second communication channel and is configured to transmit data to the computing system. In some embodiments, the master sensor can send or receive data between the computing system continuously or at periodic intervals. A geolocation module of the computing system can receive, store, and update the quantity data and geographical location data from the master sensor.

In one example embodiment, if one of the packages associated with one of the sensors is moved to an area that is out of range of the master sensor, the moved sensor will not be detected when the master sensor pings the other sensors. In such a scenario, the master sensor can determine that one less package is located at that geographical location, and the master sensor can communicate an updated set of quantity data to the computing system.

In step 105, a replacement master sensor is selected from the other sensors in response to the master sensor failing to communicate with the other sensors for a predetermined period of time. In some embodiments, the package associated with the master sensor can be moved to a different location that is out of range of the remaining sensors, or the battery associated with the master sensor can lose power,

thus leaving the remaining sensors essentially cut off from the computing system. Even though the master sensor is out of communication with the computing system and the remaining sensors, the remaining sensors can still communicate with each other over the first communication channel. Once the master sensor fails to communicate with the remaining sensors for a predetermined period of time, the replacement master sensor can be selected based on predefined criteria. In some embodiments, the replacement master sensor can be selected based on a comparison of the battery life between the other sensors. For example, each of the other sensors can communicate with each other over the first communication channel and collectively select the sensor with the highest battery charge to be the replacement master sensor. In alternative embodiments, the replacement master sensor can be selected based on a comparison of signal strength with respect to the second communication channel. For example, each of the other sensors can communicate with each other over the first communication channel to determine which sensor has the strongest signal over the second communication channel for communicating with the computing system and select that sensor as the replacement master sensor.

In step 107, the replacement master sensor retrieves quantity data and geographical location data associated with the group of packages by interrogating the other sensors (other than the non-responsive master sensor). The replacement master sensor can then monitor the quantity or geographical location associated with each of the remaining packages similar to the functions performed by the original master sensor as discussed above in reference to step 103.

In step 109, the replacement master sensor automatically initiates communication with the computing system over the second communication channel and informs the communication system of its new status as the replacement master sensor. Similar to the master sensor discussed above, the replacement master sensor communicates with the computing system over the second communication channel and is configured to transmit quality data and geographical location data associated with the group of packages to the second computing system. In some embodiments, the replacement master sensor can send or receive data to the computing system continuously or at periodic intervals.

In step 111, the computing system receives the quantity data and the geographical location data associated with the group of packages over the second communication channel using a geolocation module and updates a database of package information. In exemplary embodiments, the computing system initially receives the quantity data and geographical location data from the master sensor, and subsequently receives the quantity data and geographical location data from the replacement master sensor once the replacement master sensor is selected. The master sensor and the replacement master sensor can be placed in an active power mode, in some embodiments, while at least a subset of the other sensors are placed in a low power mode when not communicating over the second communication channel.

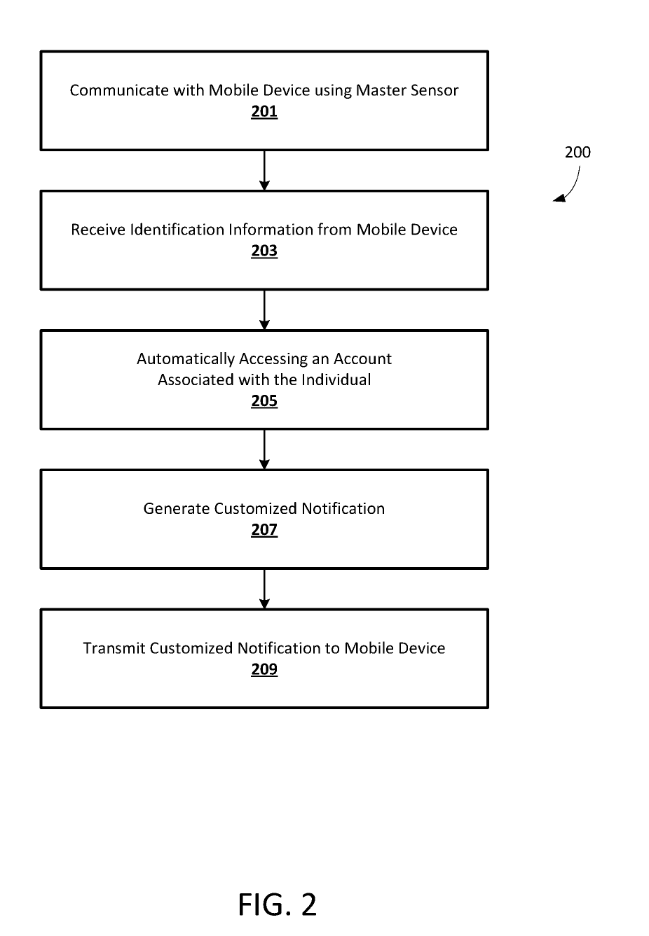

FIG. 2 is a flowchart illustrating another exemplary method 200 for communicating with a mobile device using a master sensor, according to an exemplary embodiment. It will be appreciated that the method is programmatically performed, at least in part, by one or more computer-executable processes executing on, or in communication with one or more servers described further below. In step 201, a master sensor, as described above in reference to FIG. 1, communicates with a mobile electronic device associated with an individual in proximity to the master sensor. In some embodiments, the mobile electronic device can include a personal mobile electronic device, an electronic shopping aid device, or a device associated with a shopping cart or basket within a retail store. The master sensor can detect the presence of, and communicate with, the mobile electronic device using any suitable wireless technology, for example BLE, Wi-Fi, or NFC.

In step 203, the master sensor receives identification information from the mobile electronic device. The identification information can be used to identify the individual associated with the mobile electronic device and access an account associated with the individual.

In step 205, the computing system automatically accesses an account associated with the individual in response to receiving the identification information from the master sensor. In some embodiments, the account can be a personalized account that includes virtual shopping lists, shopping patterns, product preferences, or additional data associated with the individual. The individual can access or update the account remotely or using a mobile or web application, in some embodiments.

In step 207, the computing system can generate a customized notification, using a notification module, based on information in the individual's account. For example, the information in the individual's account can indicate that the individual frequently purchases a particular product or has recently purchased a related product. This information can be used to generate a customized notification, such as a promotional sale or discount.

In step 209, the master sensor can transmit the customized notification to the mobile electronic device. In some embodiments, the master sensor can detect the presence of, communicate with, and transmit the customized notification using BLE, Wi-Fi, NFC, or other wireless technologies.

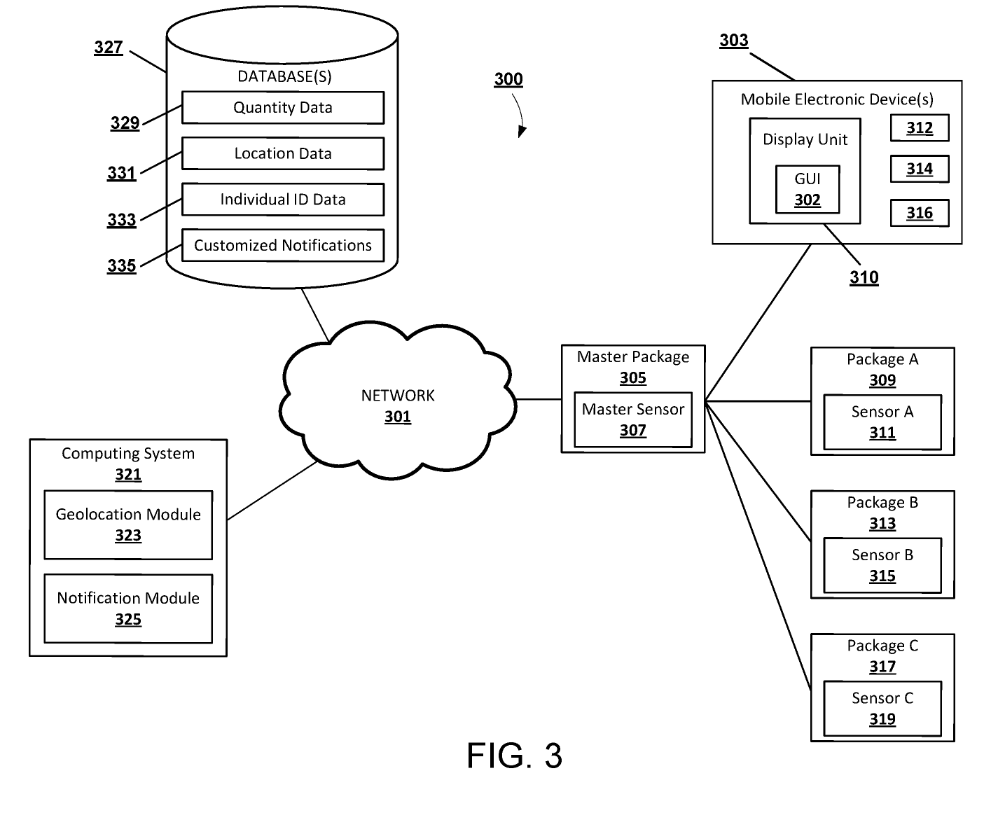

FIG. 3 illustrates a network diagram depicting a system 300 suitable for a distributed implementation of an exemplary embodiment. The system 300 can include a network 301, a mobile electronic device 303, a computing system 321, a database 327, and a group of packages. In exemplary embodiments, the group of packages includes a master package 305 associated with a master sensor 307, and a number of remaining packages 309, 313, and 317 associated with a number of individual sensors 311, 315, and 319, respectively. In some embodiments, each of the sensors 307, 311, 315, and 319 can be an embedded circuit in one of the individual packages 305, 309, 313, and 317. The master sensor 307 can be in communication with the computing system 321 over the network 301, while each of the sensors 311, 315, and 319 can be in communication with the master sensor 307, as discussed above. The master sensor 307 can also detect the presence of and be in communication with the mobile electronic device 303, as discussed above in reference to FIG. 2. As will be appreciated, various distributed or centralized configurations may be implemented without departing from the scope of the present invention. In exemplary embodiments,

computing system 321 can store and execute a geolocation module 323 and a notification module 325 which can implement one or more of the processes described herein with reference to FIGS. 1-2, or portions thereof. It will be appreciated that the module functionality may be implemented as a greater number of modules than illustrated and that the same server or computing system could also host multiple modules. The database 327 can store the quantity data 329, location data 331, individual identification data 333, and the customized notifications 335, as discussed herein. In some embodiments, the geolocation module 323 can communicate with the master sensor 307 to receive quantity and geographical location data, and the notification module 325 can communicate with the master sensor 307 to transmit a customized notification to the mobile electronic device 303, as described herein.

As discussed above in reference to FIG. 1, if the master sensor 307 loses communication with the remaining sensors 311, 315, and 319, the other sensors 311, 315, and 319 can communicate with each other and select a replacement master sensor. The replacement master sensor can be selected, in some embodiments, based on a comparison of the battery life or signal strength between the other remaining sensors 311, 315, and 319.

In exemplary embodiments, the mobile electronic device 303 may include a display unit 310, which can display a GUI 302 to a user of the mobile electronic device 303. The mobile electronic device can also include a memory 312, processor 314, and a wireless interface 316. In some embodiments, the mobile electronic device 303 may include, but is not limited to, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, multi-processor systems, microprocessor-based or programmable consumer electronics, game consoles, network PCs, mini-computers, smartphones, and the like.

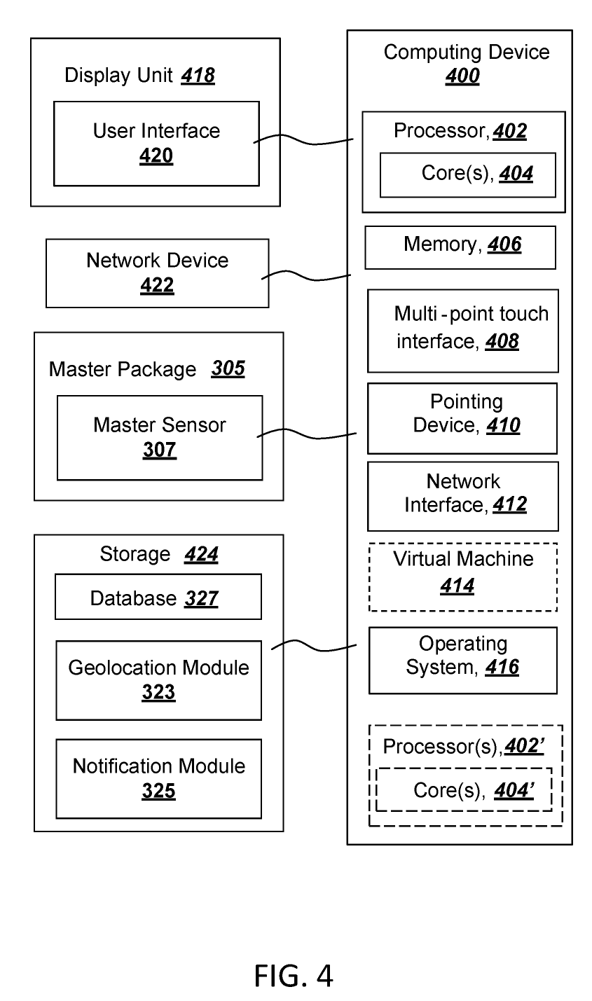

The master sensor 307 and the computing system 321 may connect to the network 301 via a wireless connection, and the computing system 321 may include one or more applications such as, but not limited to, a web browser, a sales transaction application, an object reader application, a geo-location application, and the like. The computing system 321 may include some or all components described in relation to computing device 400 shown in FIG. 4.

The communication network 301 may include, but is not limited to, the Internet, an intranet, a LAN (Local Area Network), a WAN (Wide Area Network), a MAN (Metropolitan Area Network), a wireless network, an optical network, and the like. In one embodiment, the master sensor 307, computing system 321, and database 327 can transmit instructions to each other over the communication network 301. In exemplary embodiments, the quantity data 329, location data 331, individual identification data 333, and customized notifications 335 can be stored at the database 327 and received at the master sensor 307 or the computing system 321 in response to a service performed by a database retrieval application.

FIG. 4 is a block diagram of an exemplary computing device 400 that can be used in the performance of the methods described herein. The computing device 400 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 406 included in the computing device 400 can store computer-readable and computer-executable instructions or software for implementing exemplary embodiments and programmed to perform processes described above in reference to FIGS. 1-2. The computing device 400 also includes processor 402 and associated core 404, and optionally, one or more additional processor(s) 402′ and associated core(s) 404′ (for example, in the case of computer systems having multiple processors/cores), for executing computer-readable and computer-executable instructions or software stored in the memory 406 and other programs for controlling system hardware. Processor 402 and processor(s) 402′ can each be a single core processor or multiple core (404 and 404′) processor.

Virtualization can be employed in the computing device 400 so that infrastructure and resources in the computing device can be shared dynamically. A virtual machine 414 can be provided to handle a process running on multiple processors so that the process appears to be using only one computing resource rather than multiple computing resources. Multiple virtual machines can also be used with one processor.

Memory 406 can be non-transitory computer-readable media including a computer system memory or random access memory, such as DRAM, SRAM, EDO RAM, and the like. Memory 406 can include other types of memory as well, or combinations thereof.

A user can interact with the computing device 400 through a display unit 418, such as a touch screen display or computer monitor, which can display one or more user interfaces 420 that can be provided in accordance with exemplary embodiments. The computing device 400 can also include other I/O devices for receiving input from a user, for example, a keyboard or any suitable multi-point touch interface 408, a pointing device 410 (e.g., a pen, stylus, mouse, or trackpad). The multi-point touch interface 408 and the pointing device 410 can be coupled to the display unit 418. The computing device 400 can include other suitable conventional I/O peripherals.

The computing device 400 can also include one or more storage devices 424, such as a hard-drive, CD-ROM, or other non-transitory computer readable media, for storing data and computer-readable instructions and/or software, such as a geolocation module 323 and a notification module 325 that can implement exemplary embodiments of the methods and systems as taught herein, or portions thereof. Exemplary storage device 424 can also store one or more databases 327 for storing any suitable information required to implement exemplary embodiments. The database 327 can be updated by a user or automatically at any suitable time to add, delete, or update one or more items in the databases. Exemplary storage device 424 can store a database 327 for storing the quantity data 329, location data 331, individual identification data 333, customized notifications 335, and any other data/information used to implement exemplary embodiments of the systems and methods described herein.

The computing device 400 can also be in communication with a master sensor 307 associated with a master package 305. In exemplary embodiments, the computing device 400 can include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 can include a built-in network adapter, network interface card, PCMCIA network card, card bus network adapter, wireless network adapter, USB network adapter, modem or any other device suitable for interfacing the computing device 400 to any type of network capable of communication and performing the operations described herein. Moreover, the computing device 400 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 400 can run operating system 416, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or other operating systems capable of running on the computing device and performing the operations described herein. In exemplary embodiments, the operating system 416 can be run in native mode or emulated mode. In an exemplary embodiment, the operating system 416 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with multiple elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system for monitoring packages with affixed sensors within a facility, the system comprising:
a plurality of sensors each associated with, and affixed to, one of a plurality of packages and configured to communicate with each other over a first communication channel,
a master sensor selected from the plurality of sensors and configured to periodically retrieve quantity data associated with the plurality of packages and geographical location data associated with the plurality of packages by interrogating other sensors of the plurality of sensors over the first communication channel;
a computing system in communication with the master sensor over a second communication channel and configured to execute a geolocation module to:
receive the quantity data and the geographical location data associated with the plurality of packages from the master sensor; and
dynamically update a database to include the quantity data and the geographical location data associated with the plurality of packages; and
a replacement master sensor selected from the other sensors of the plurality of sensors in response to the master sensor failing to communicate with the other sensors of the plurality of sensors over the first communication channel for a predetermined period of time, the replacement master sensor selected based on predefined criteria following the other sensors of the plurality of sensors communicating with each other over the first communication channel after the master sensor fails to communicate for the predetermined period of time, wherein the replacement master sensor is configured to:
periodically retrieve the quantity data and the geographical location data associated with the plurality of packages by interrogating the other sensors of the plurality of sensors over the first communication channel; and
automatically initiate communication with the computing system over the second communication channel to transmit the quantity data and the geographical location data associated with the plurality of packages to the computing system,
wherein the master sensor and replacement master sensor are placed in an active power mode and at least a subset of the other sensors of the plurality of sensors are placed in a low power mode when not communicating over the second communication channel.

2. The system of claim 1, wherein the master sensor is further configured to communicate with a mobile electronic device associated with an individual in proximity to the master sensor and receive identification information from the mobile electronic device.

3. The system of claim 2, wherein the computing system is further configured to execute a notification module to:
automatically access an account associated with the individual in response to receiving the identification information from the master sensor;
generate a customized notification based on information in the individual's account; and
transmit the customized notification to the mobile electronic device.

4. The system of claim 1, wherein the plurality of sensors are Bluetooth low energy beacons.

5. The system of claim 1, wherein each of the plurality of sensors is part of an embedded circuit in one of the plurality of packages.

6. The system of claim 1, wherein the master sensor and the replacement master sensor are selected based on a comparison of battery life with the other sensors of the plurality of sensors.

7. The system of claim 1, wherein the master sensor and the replacement master sensor are selected based on a comparison of signal strength with respect to the second communication channel.

8. A method for monitoring packages with affixed sensors within a facility, the method comprising:
selecting a master sensor from a plurality of sensors each associated with, and affixed to, one of a plurality of packages, each of the plurality of sensors configured to communicate with each other over a first communication channel;
retrieving quantity data associated with the plurality of packages and geographical location data associated with the plurality of packages by interrogating other sensors of the plurality of sensors, using the master sensor, wherein the master sensor is in communication with a computing system over a second communication channel;
selecting a replacement master sensor from the other sensors of the plurality of sensors in response to the master sensor failing to communicate with the other sensors of the plurality of sensors over the first communication channel for a predetermined period of time, the replacement master sensor selected based on predefined criteria following the other sensors of the plurality of sensors communicating with each other over the first communication channel after the master sensor fails to communicate for the predetermined period of time;
retrieving the quantity data associated with the plurality of packages and the geographical location data associated with the plurality of packages by interrogating the other sensors of the plurality of sensors using the replacement master sensor;
automatically initiating communication between the replacement master sensor and the computing system over the second communication channel to transmit the quality data and the geographical location data associated with the plurality of packages to the computing system; and
receiving the quantity data and the geographical location data associated with the plurality of packages at the computing system over the second communication channel;
wherein the master sensor and the replacement master sensor are placed in an active power mode and at least a subset of the other sensors of the plurality of sensors are placed in a low power mode when not communicating over the second communication channel.

9. The method of claim 8, further comprising:
communicating, using the master sensor, with a mobile electronic device associated with an individual in proximity to the master sensor; and
receiving at the master sensor identification information from the mobile electronic device.

10. The method of claim 9, further comprising:
automatically accessing an account associated with the individual, using the computing system, in response to receiving the identification information from the master sensor;
generating a customized notification based on information in the individual's account; and
transmitting the customized notification to the mobile electronic device.

11. The method of claim 8, wherein the plurality of sensors are Bluetooth low energy beacons.

12. The method of claim 8, wherein each of the plurality of sensors is part of an embedded circuit in one of the plurality of packages.

13. The method of claim 8, wherein selecting the master sensor and selecting the replacement master sensor is based on a comparison of battery life with the other sensors of the plurality of sensors.

14. The method of claim 8, wherein selecting the master sensor and selecting the replacement master sensor is based on a comparison of signal strength with respect to the second communication channel.

15. A non-transitory machine readable medium storing instructions executable by a processing device, wherein execution of the instructions causes the processing device to implement a method for monitoring packages with affixed sensors within a facility, the method comprising:
selecting a master sensor from a plurality of sensors each associated with, and affixed to, one of a plurality of packages, each of the plurality of sensors configured to communicate with each other over a first communication channel;
retrieving quantity data associated with the plurality of packages and geographical location data associated with the plurality of packages by interrogating other sensors of the plurality of sensors, using the master sensor, wherein the master sensor is in communication with a computing system over a second communication channel;
selecting a replacement master sensor from the other sensors of the plurality of sensors in response to the master sensor failing to communicate with the other sensors of the plurality of sensors over the first communication channel for a predetermined period of time, the replacement master sensor selected based on predefined criteria following the other sensors of the plurality of sensors communicating with each other over the first communication channel after the master sensor fails to communicate for the predetermined period of time;
retrieving the quantity data associated with the plurality of packages and the geographical location data associated with the plurality of packages by interrogating the other sensors of the plurality of sensors using the replacement master sensor;
automatically initiating communication between the replacement master sensor and the computing system over the second communication channel to transmit the quality data and the geographical location data associated with the plurality of packages to the computing system; and
receiving the quantity data and the geographical location data associated with the plurality of packages at the computing system over the second communication channel;
wherein the master sensor and the replacement master sensor are placed in an active power mode and at least a subset of the other sensors of the plurality of sensors are placed in a low power mode when not communicating over the second communication channel.

16. The non-transitory machine readable medium of claim 15, wherein execution of the instructions further causes the processing device to:
communicate, using the master sensor, with a mobile electronic device associated with an individual in proximity to the master sensor; and
receive at the master sensor identification information from the mobile electronic device.

17. The non-transitory machine readable medium of claim 16, wherein execution of the instructions further causes the processing device to:
automatically access an account associated with the individual, using the computing system, in response to receiving the identification information from the master sensor;
generate a customized notification based on information in the individual's account; and
transmit the customized notification to the mobile electronic device.

18. The non-transitory machine readable medium of claim 15, wherein each of the plurality of sensors is part of an embedded circuit in one of the plurality of packages.

19. The non-transitory machine readable medium of claim 15, wherein selecting the master sensor and selecting the replacement master sensor is based on a comparison of battery life with the other sensors of the plurality of sensors.

20. The non-transitory machine readable medium of claim 15, wherein selecting the master sensor and selecting the replacement master sensor is based on a comparison of signal strength with respect to the second communication channel.
